(19) United States
(12) Patent Application Publication
(10) Pub. No.: US 2011/0307399 A1
(43) Pub. Date: Dec. 15, 2011

(54) Live Event Social Networking System

(76) Inventor: Brian Holmes, Phoenix, AZ (US)

(21) Appl. No.: 13/156,792

(22) Filed: Jun. 9, 2011

Related U.S. Application Data
(60) Provisional application No. 61/353,010, filed on Jun. 9, 2010.

(51) Int. Cl. G06Q 30/00

(52) U.S. Cl. 705/319

(57) ABSTRACT

Embodiments of the invention provide a method for location-based social networking including creating a user profile. In some embodiments, creating the profile can include receiving user data, storing the data in a database, and distributing a reward to the user for creating the profile. The method can include determining a location of the user using one of a global positioning system (GPS) and data input from the user and displaying at least one event. In some embodiments, the selection of the event can be based on the location of the event. In some embodiments, the method can include receiving an event check-in instruction from the GPS or the user and distributing another reward to the user. Also, the method can include receiving and displaying a user comment regarding the event. In some embodiments, the method can include transmitting the comment to a social networking account.

### RELATED APPLICATIONS

This application claims priority under 35 U.S.C. §119 to U.S. Provisional Patent Application No. 61/353,010 filed on Jun. 9, 2010 the entire contents of which is incorporated herein by reference.

### BACKGROUND

Some technology startups have achieved success with online technologies that allow people to stay in touch and share experiences with their friends. Two of the most famous examples of these technologies are Facebook® and Twitter®. Facebook® has achieved success by allowing people to stay in touch with their contacts, while Twitter® has achieved success by letting people share what they are doing with the public.

The next evolution of this technology is allowing users to interact with their location and share it with their friends using their mobile device. This technology is referred to as location-based social networking. Location based social networking has been made possible due to the proliferation of portable electronic devices and their ability to track a user's location using global positioning system and other similar systems, and share data about that location using an interconnected network, such as the Internet.

### SUMMARY

Some embodiments of the invention provide a method for location-based social networking including creating a user profile. In some embodiments, creating the profile can include receiving user data, storing the data in a database, and distributing a reward to the user for creating the profile. The method can include determining a location of the user using one of a global positioning system (GPS) and data input from the user and displaying at least one event. In some embodiments, the selection of the event can be based on the location of the event. In some embodiments, the method can include receiving an event check-in instruction from the GPS or the user and distributing another reward to the user. Also, the method can include receiving and displaying a user comment regarding the event. In some embodiments, the method can include transmitting the comment to a social networking account.

Some embodiments of the invention provide a method for location-based social networking. In some embodiments the method can comprise displaying at least two pages that are configured and arranged to receive data at least partially related to event preferences. In some embodiments, the method can include receiving the data so that a GPS generates at least a portion of the data. In some embodiments, the method can include storing the data in a system database, displaying at least a portion of the data on a welcome page, and distributing a first reward based upon receipt of the data. The method also can include displaying at least one event on the welcome page. In some embodiments, the event can be selected in part based on the data received. In some embodiments, the method can including receiving an event check-in instruction and distributing a second reward at least partially based on receiving the event check-in instruction. In some embodiments, the method can include receiving and displaying at least one first comment related to the event. In some embodiments, the first comment can originate from a location substantially proximal to the event. In some embodiments, the method can include receiving at least one second comment in response to the first comment and transmitting at least one of the first comment and the second comment to at least one social networking system.

### DESCRIPTION OF THE DRAWINGS

FIGS. 1A-1C are different views of portions of an architecture of a location-based social networking system according some embodiments of the invention.

FIG. 2 is a representation of a sign-up page of the location-based social networking system of FIG. 1.

FIG. 3 is a representation of a user login page of the location-based social networking system of FIG. 1.

FIG. 4 is a representation of a terms and conditions page of the location-based social networking system of FIG. 1.

FIG. 5 is a representation of a privacy policies page of the location-based social networking system of FIG. 1.

FIG. 6 is a representation of an artist preference page of the location-based social networking system of FIG. 1.

FIG. 7 is a representation of a location page of the location-based social networking system of FIG. 1.

FIG. 8 is a representation of a welcome page of the location-based social networking system of FIG. 1.

FIG. 9 is a representation of a profile edit page of the location-based social networking system of FIG. 1.

FIG. 10 is a representation of an upload image page of the location-based social networking system of FIG. 1.

FIG. 11 is a representation of a social networks page of the location-based social networking system of FIG. 1.

FIG. 12 is a representation of a Facebook® page of the location-based social networking system of FIG. 1.

FIG. 13 is a representation of a Twitter® page of the location-based social networking system of FIG. 1.

FIG. 14 is a representation of an edit preferences page of the location-based social networking system of FIG. 1.

FIG. 15 is a representation of a change location page of the location-based social networking system of FIG. 1.

FIG. 16 is a representation of a badges page of the location-based social networking system of FIG. 1.

FIG. 17 is a representation of a badge rules page of the location-based social networking system of FIG. 1.

FIG. 18 is a representation of a top badge performers page of the location-based social networking system of FIG. 1.

FIG. 19 is a representation of a forward to a friend page of the location-based social networking system of FIG. 1.

FIG. 20 is a representation of an events page of the location-based social networking system of FIG. 1.

FIG. 21 is a representation of an awards page of the location-based social networking system of FIG. 1.

FIG. 22 is a representation of an award rules page of the location-based social networking system of FIG. 1.

FIG. 23 is a representation of a top award performers page of the location-based social networking system of FIG. 1.

FIG. 24 is a representation of a news page of the location-based social networking system of FIG. 1.

FIG. 25 is a representation of an event details page of the location-based social networking system of FIG. 1.

FIG. 26 is a representation of a directions page of the location-based social networking system of FIG. 1.

FIG. 27 is a representation of a forum page of the location-based social networking system of FIG. 1.

FIG. 28 is a representation of a prior attendance page of the location-based social networking system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention provide a location-based social network system 10 that can enable one or more users 12 (e.g., fans and/or participants of an event or social occasion) to interact with live events, be informed about upcoming events, share their event experiences with other users 12 (e.g., the user's friends, acquaintances, co-attendees of a given event, and others with similar interests), and/or earn rewards for attending live events. Although future references are to “users,” a single user is encompassed within this plural term and vice versa. In some embodiments, the system 10 can function with a device 14. For example, in some embodiments, the device can comprise an operating system and a processor that can be at least partially employed by the system 10. In some embodiments, the device 14 can comprise a computer (e.g., a personal computer, a laptop computer, a tablet such as an iPad®, etc.), a mobile device, a personal digital assistant (PDA), a smartphone (e.g., a BlackBerry®, an iPhone®, an Android®-based communication device, etc.), or other mobile communication device in communication with a network, such as the Internet or a telecommunications network.

In some embodiments, the live events can comprise a plurality of gatherings. For example, in some embodiments, the live events can comprise music events such as concerts, sporting events, festivals, tournaments, scholastic events, other live events, or any combination thereof. In some embodiments, the user 12 can access and/or initiate the system 10 via their device 14, for example, using a user interface 16 displayed on the device 14. In some embodiments, by initiating the system 10, the user 12 can at least partially enable the system 10 to communicate with a system service over the network. In some embodiments, a plurality of users 12 can each have a personal system 10 account with the system service.

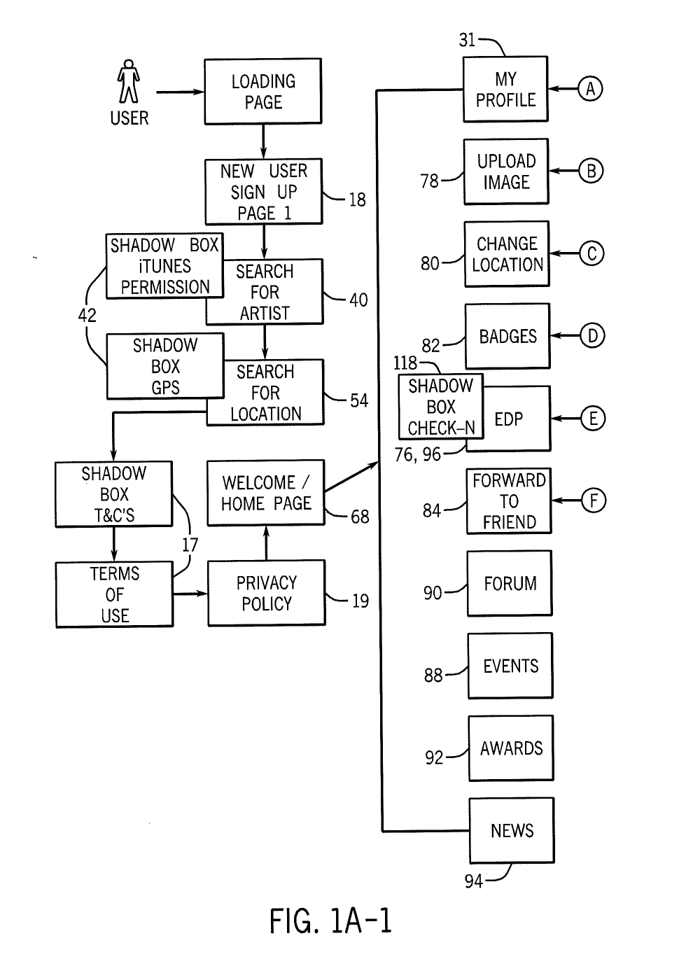

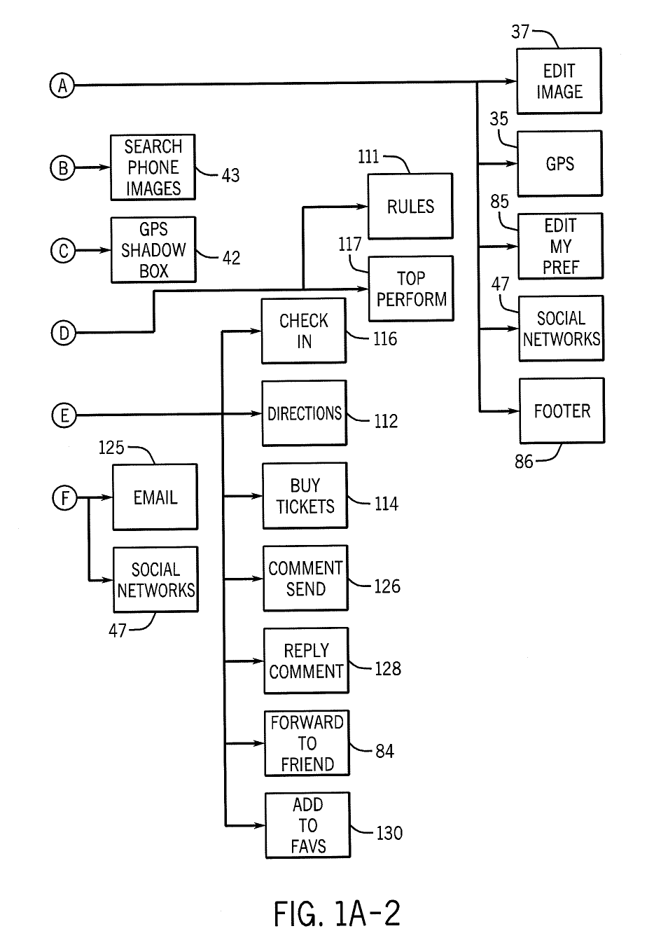

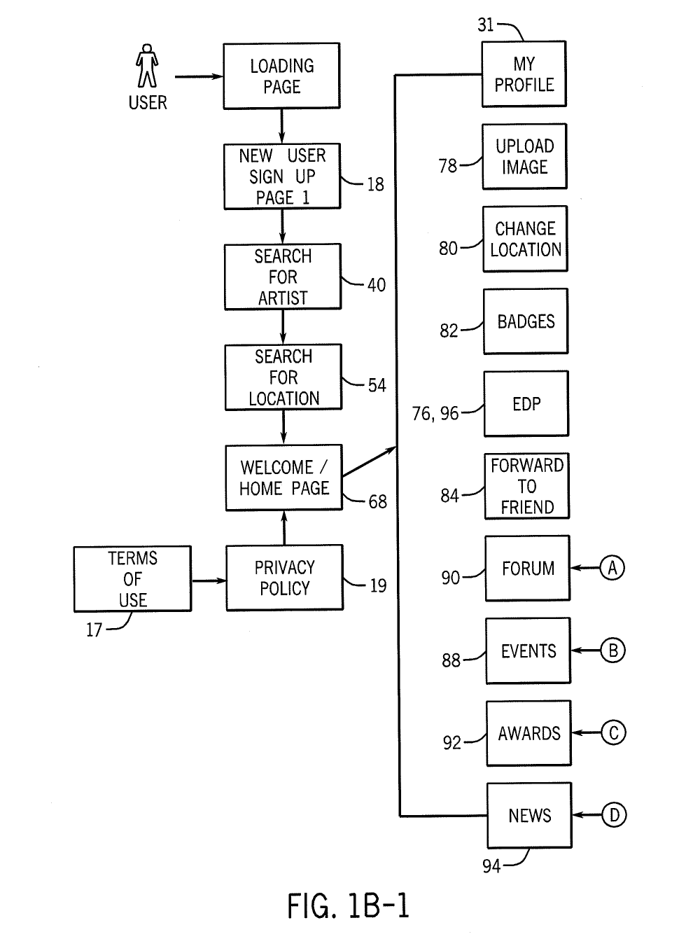

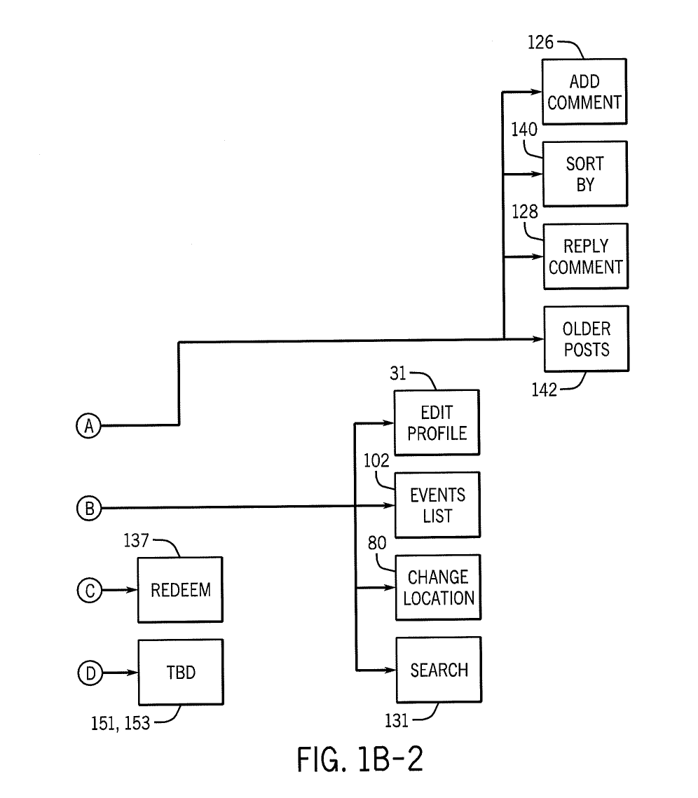

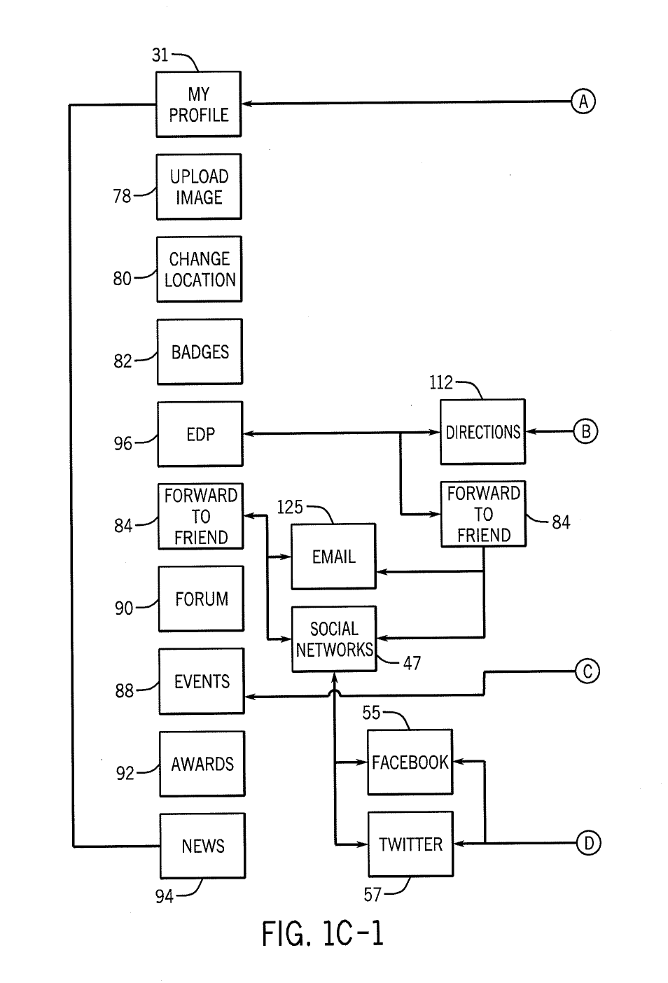

As shown in FIGS. 1A-1C, the system 10 can comprise multiple steps, interactions, inputs, communications, and/or selections. The following discussion is an example of some embodiments of the system 10. Although the following discussion of the system 10 is arranged in a series steps, interactions, and/or options, the order of the steps need not be as follows and can be reordered to meet user 12 and/or system 10 requirements.

As shown in FIGS. 1A-2, in some embodiments, the system 10 can include the user 12 creating a user profile. In some embodiments, creating a user profile can include inputting information (i.e., a plurality of data inputs) into the system 10 for analysis via the user interface 16. In some embodiments, the user 12 can create a user account for unique identification on the system 10. For example, in some embodiments, after the user 12 initiates the system 10, a sign up page 18 can be displayed on the user interface 16 of the device 14. In some embodiments, the sign up page 18 can be enable the user 12 to input potentially relevant information for use on the system 10.

Referring to FIG. 2, in some embodiments, the system 10 can receive at least a portion of a user's 12 relevant information via the sign up page 18. In some embodiments, when the user 12 is at the sign up page 18, the system 10 can display a number of fields configured and arranged to receive user information. For example, in some embodiments, when at the sign up page 18, the user 12 can input a variety of information via the user interface 16. For example, in some embodiments, the information can comprise a first name 20, a last name 22, a date of birth 24, an e-mail address 26, a password 28, a phone number 30, and/or a gender 32. Moreover, in some embodiments, the system 10 can require repeated entry of important information to ensure no errors occurred during field completion. For example, as shown in FIG. 2, in some embodiments, the user 12 may have to input their e-mail address 26 more than one time to at least partially ensure correctness. In some embodiments, at least a portion of this information can be relevant for making determinations on the social habits and interests of different users 12.

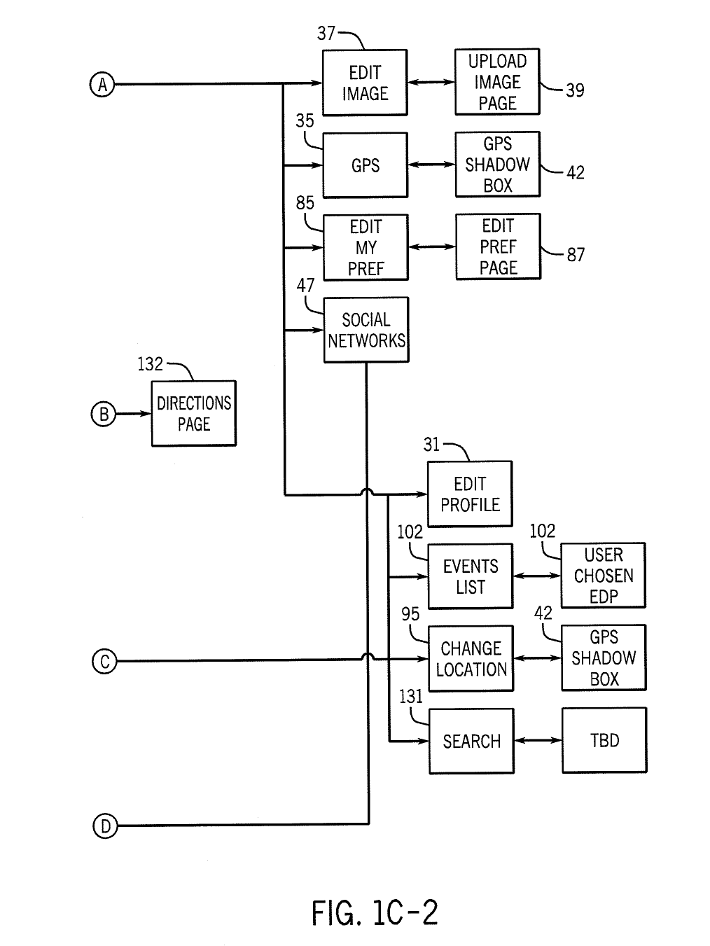

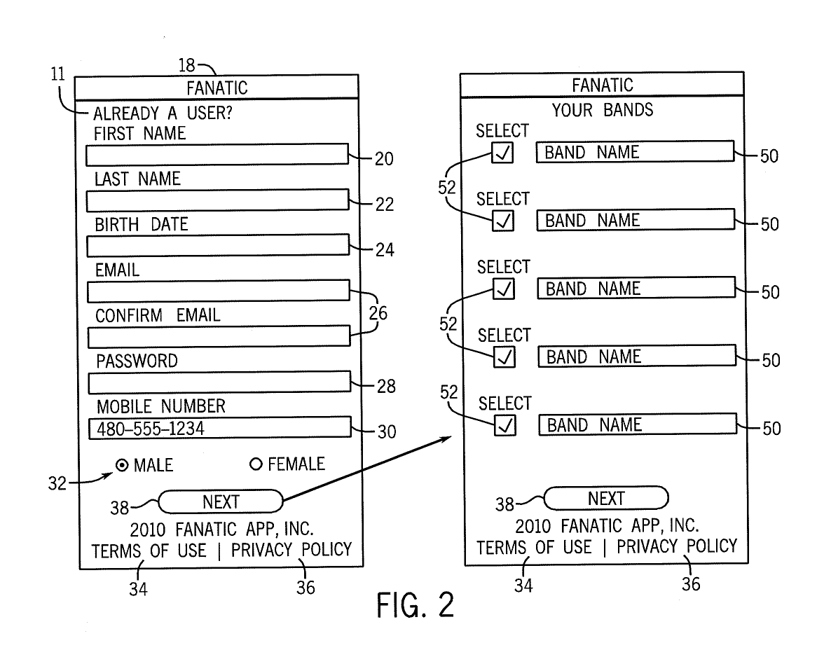

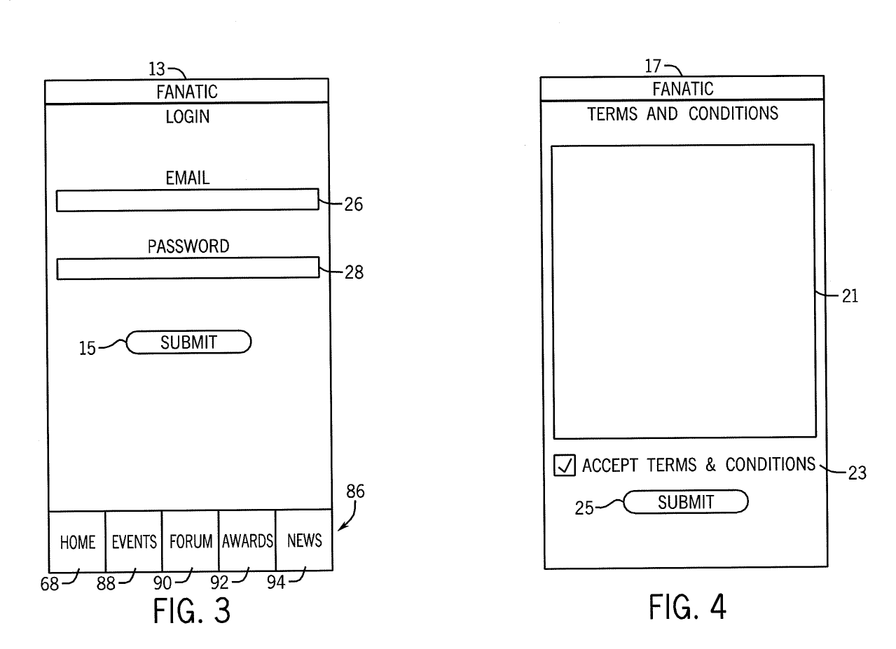

Moreover, in some embodiments, the sign-up page can include a link 11 to a login page 13. For example, as shown in FIG. 3, in some embodiments, the login page 13 can include fields for entry of the user's e-mail address 26 (e.g., for use a username) and the user's password 28 that the user entered into the fields on the sign-up page 18. Additionally, in some embodiments, the login page 13 can include a submit button 15 that the user 12 can select after inputting their e-mail address and password. For example, in some embodiments, after the user 12 selects the submit button 15, the system 10 can verify that the information is correct and allow the user 12 to access the system 10. Also, in some embodiments, the login page 13 can be the initial page displayed by the system 10 after the user 12 creates their user profile.

Additionally, in some embodiments, different system 10-based information can be displayed on the sign up page 18 and other pages displayed by the system 10. For example, in some embodiments, the user interface 16 also can display the system's 10 terms of use 34 and/or privacy policy 36. In some embodiments, the terms of use 34 and/or the privacy policy can inform users 12 about their potential rights and obligations associated with use of the system 10.

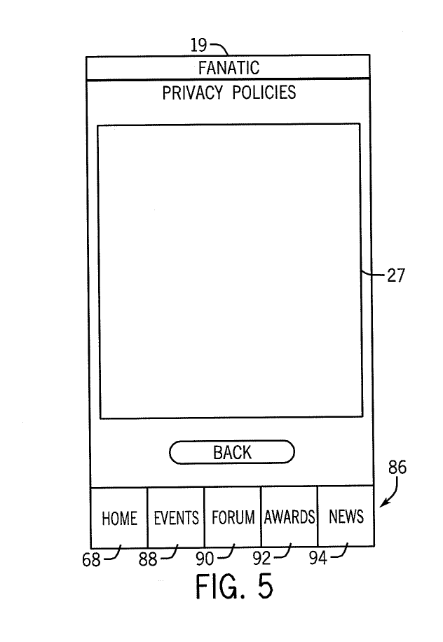

By way of example only, in some embodiments, during the creation of the user's profile, the system 10 can require the user 12 to review the terms of use 34 and/or the privacy policy 36. For example, as shown in FIGS. 4 and 5, in some embodiments, the system 10 can display a terms of use page 17 and/or a privacy page 19. In some embodiments, the terms of use page 17 can contain the system's 10 administrators' terms 21 required to be accepted by users 12 before using the system 10. Additionally, in some embodiments, the terms of use page 17 can include an acceptance field 23 that the user 12 must mark in order to use the system 10. In some embodiments, the terms of use page 17 can include a submit button 25 that the user can select after reviewing and accepting the term of use 21. Moreover, in some embodiments, the system 10 also can display the privacy policies page 19. In some embodiments, the privacy policies page 19 can include the privacy policies 27 of the system 10 (e.g., with whom and under what circumstances the system 10 will share information regarding users 12). In some embodiments, the privacy policies page 19 can include a back or return button 29 that the user 12 can select after viewing the privacy policies 27 to return to the page from which the user 12 navigated.

In some embodiments, the system 10 can at least semi-permanently store the user's information on one or more databases of the network. For example, in some embodiments, after entering at least a portion of their information, the user 12 can select next 38 to signal the system 10 to store the data on the network. For example, in some embodiments, at least a portion of the user's data can be transmitted to and/or stored at one or more customer relationship management databases for future access by the system 10, the users 12, and/or third parties.

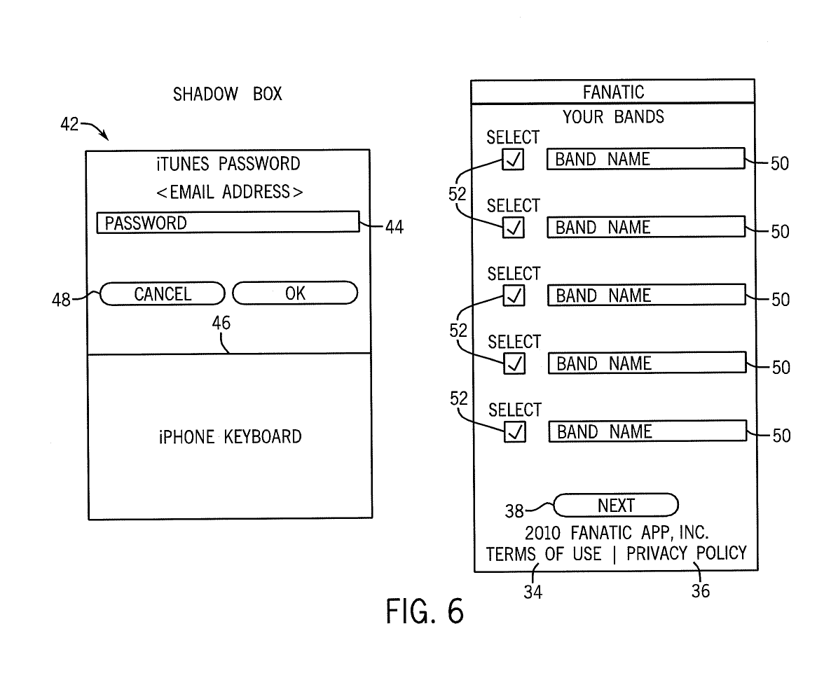

In some embodiments, the system 10 can display data-input fields related to some other user profile-specific information. For example, in some embodiments, the system 10 can receive data related to the user's 12 event preferences, as shown in FIGS. 1 and 2. In some embodiments, the system 10 can request the user's 12 artist preferences at an artist preferences page 40. In some embodiments, the system 10 can comprise the capability to perform at least one of a substantially automatic search for artist preferences and display data-input fields so that the user 12 can input their artist preferences. For example, as shown in FIG. 3, the system 10 can request the user's 12 permission to access a music library found on the device 14 or elsewhere on the network or an associated network (e.g., cloud storage). As shown in FIG. 6, in some embodiments, the system 10 can display a shadow box 42 requesting permission (i.e., password entry) to access the user's stored data. By way of example only, in some embodiments, the system 10 can request that the user 12 input a password in a password field 44 so that the system 10 can access the user's data (e.g., the user's music library). In some embodiments, if the device 10 does not include a physical keyboard (i.e., the device 10 is a touch-screen device), the system 10 can display a keyboard 46 so that the user can input their password into the password field 44 and other data on other pages.

In some embodiments, if the user 12 inputs their password into the password field 44, the system 10 can analyze the user's stored data to determine the user's 12 preferred artists, which can be automatically displayed on the artist preferences page 40. If the user 12 decides not to input their password into the password field 44, the user 12 can select cancel 48 and manually input their data into the artist preferences pages 40. In some embodiments, regardless of the manner of data entry (e.g., automatic v. manual entry), at least a portion of a plurality of artist name fields 50 displayed on the artist preferences page 40 should include artists' names.

Moreover, in some embodiments, to suit user 12 needs, requirements, and/or desires, the artist preferences page 40 also comprises at least one select option field 52 per artist name field 50. In some embodiments, even though the system 10 can automatically determine the user's preferred artists from access to the user's stored data or the user can manually input the artists names in the artist name fields 50, the user 12 can check or uncheck the select option field 52 so that the user 12 can instruct the system 10 to either use or not use that particular artist's name in the system's analysis of the user's preferences. For example, in some embodiments, if the system 10 determines, at least partially based on the system's 10 analysis of the user's stored data, that the user 12 prefers X artist, but the user 12 does not want X artist to be a part of the user's preferred artists, the user 12 can uncheck the select option field 52. In some embodiments, after the user 12 makes their determination of which artists' names should be inputted into the artist names fields 50, the user 12 can select the Next button 38, which can signal the system 10 to transmit the user 12-inputted artist data to the one or more databases of the network.

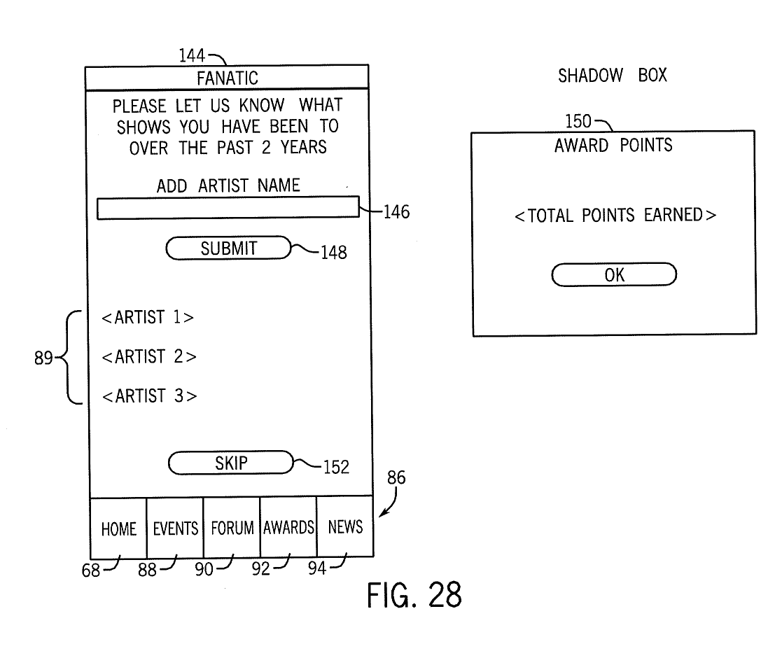

Additionally, in some embodiments, the user 12 can access a prior attendance page 144, as shown in FIG. 28. In some embodiments, the prior attendance page 144 can include at least one field 146 into which the user 12 can input the names of artists that the user 12 has gone to see live over a certain time period. For example, in some embodiments, the time period can be two years, but in other embodiments, the time period can be other time frames. Also, in some embodiments, after entering the artists name in the field 146, the user 12 can select a submit button 148 so that the system 10 can store the artists' names and display the names on the prior attendance page 144. Also, in some embodiments, the system 10 can distribute rewards (e.g., reward points) to the user 12 for submitting this information, as reflected by shadow box 150. Additionally, in some embodiments, the user 12 can decide not to input artists' names and select a skip button 152 so that the user 12 can return the remainder of the user profile-creation process.

Although many of the previously mentioned and remaining illustrations employ musical and/or other artistic nomenclature (e.g., “band name,” “artist,” “venue,” etc.), the system 10 is not limited to these fields of events. As previously mentioned, in some embodiments, the events can include sporting events, tournaments (e.g., academic, athletic, social, etc.), festivals, scholastic events, etc. By way of example only, in some embodiments, the user 12 can input information such as their favorite professional and/or collegiate athletic teams into fields analogous to the artists names fields 50.

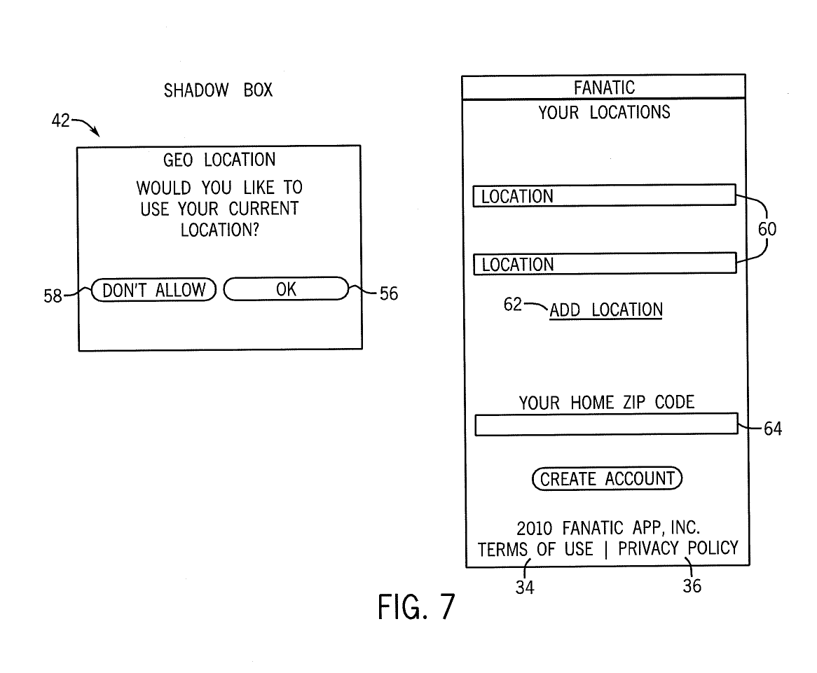

As shown in FIG. 7, in some embodiments, the system 10 also can be configured and arranged to receive information related to the user's 12 relevant locations. In some embodiments, the system 10 can display a location page 54 via the user interface 16. For example, in some embodiments, similar to the artist preferences page 40, the location page 54 can initially display a shadow box 42, which can prompt the user 12 to determine whether the user 12 wishes the to allow the system 10 to automatically assess the user's location.

In some embodiments, the system 10 can seek the user's 12 permission to access the device's 14 GPS to assess the user's location. In some embodiments, the user can grant permission to the system 10 to access the device's 14 GPS by selecting an OK button 56 or the user can deny permission by selecting a don't allow button 58. In some embodiments, the system 10 can comprise similar buttons, boxes, or selection criteria to signify the user's 12 decisions (i.e., the buttons need not always display “OK,” “Don't Allow,” “Next,” “Cancel,” etc.). In some embodiments, if the user 12 grants the system 10 permission to access and use the device's 14 GPS, location fields 60 on the location page 54 can automatically populate with at least a portion of the user's 12 location at least partially based upon the GPS data received by the system 10. Additionally, in some embodiments, the system 10 can be configured to receive multiple locations for later configurations of user 12 preferences. For example, in some embodiments, the user 12 can input their current location (or the system 10 can automatically populate the fields via GPS-based data) and other relevant locations in which the user 12 may wish to participate in live events.

In some embodiments, if the user 12 can also manually enter locations into the location fields 60. For example, in some embodiments, if the user 12 denies the system 10 permission to access and use the device's 14 GPS, the location fields 60 can remain substantially empty until the user 12 manually enters the user's location. For example, in some embodiments, if the user 12 denies permission by selecting the don't allow button, the system 10 can prompt the user to select an add location link 62 and zip code field 64 to input the user's desired locations.

Moreover, in some embodiments, in addition to populating at least a portion of the location fields 60 with GPS-based information, the user 12 also can input other relevant locations. For example, in some embodiments, the user 12 can populate at least a portion of the location fields 60 with the user's current location (e.g., Phoenix, Ariz.). In some embodiments, the user 12 also can input names of other locations (e.g., Flagstaff, Ariz., Mesa, Ariz., Denver, Colo., Detroit, Mich., etc.) where the user 12 may wish to participate in or receive notice of live events.

In some embodiments, after the user 12 inputs the required information to establish a user profile, the user 12 can select a create account button 66 and the system 10 can analyze the user's 12 input. Additionally, in some embodiments, the system 10 can display the terms of use page 17 after the user 12 selects the create account button 66 to ensure that the user 12 is aware of the system's 10 requirements. By way of example only, in some embodiments, the analysis of the system 10 can make determinations regarding which live events including which artists and in which locations the user can and/or should receive notices. Moreover, in some embodiments, upon selecting the create account button 66, the system 10 can issue a number of rewards points for the creation of the user's profile and/or account.

In some embodiments, by at least partially inputting data requested during the user profile creation process, the user 12 can further access and make use of the system 10. Although, in some embodiments, the user 12 need not complete all or any of the user profile creation process in order to access and make sure of the system 10. For example, in some embodiments, the system 10 can enable the user 12 to “follow” artists, teams, events, or a specific location (e.g., the user's locations as previously mentioned). In some embodiments, as described in more detail below, the user 12 can receive news updates for their followed artists, teams, locations, or events based on their personal settings. For example, in some embodiments, the news updates can include upcoming events in the event location, tour schedules of followed artists, new releases, upcoming sporting events, etc. In addition, as described in further detail below, in some embodiments, through the system 10, the user 12 can browse a calendar of upcoming events, for example categorized by location, sport, team, music genre, artist, etc. In some embodiments, the user 12 can retrieve detailed information for the event including, but not limited to, time, location, performing artists, etc. Moreover, in some embodiments, the user 12 can also discuss events with other users (e.g., through comment areas, as described in further detail below), view or add tips related to events, and broadcast through other social networking services regarding the user's 12 participation at some of the events.

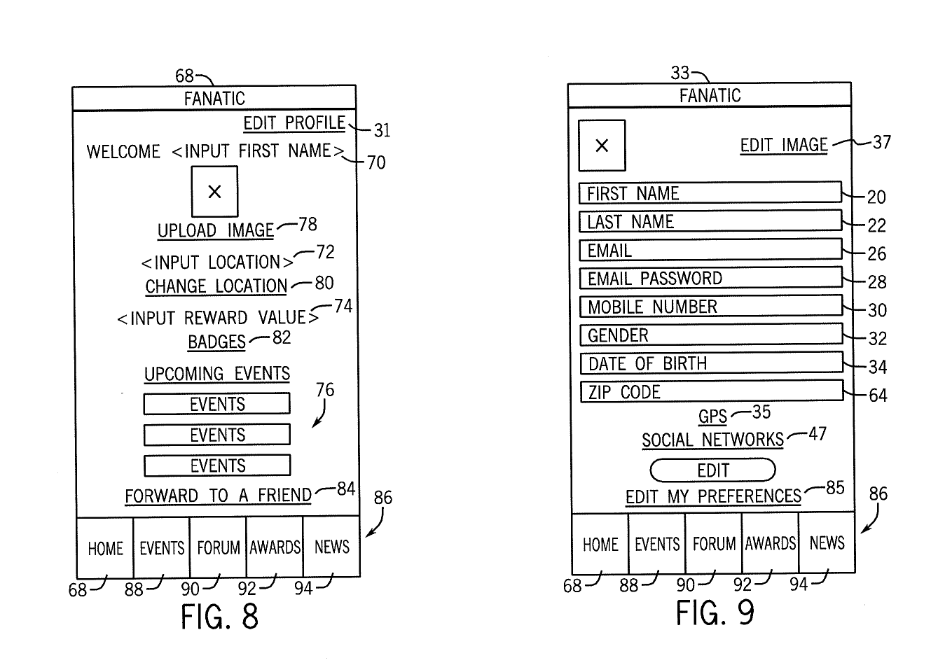

In some embodiments, before, after, or during creation of the user's profile, the system 10 can display to the user 12 a welcome page 68, as shown in FIG. 8. In some embodiments, the welcome page 68 can comprise other names such as a home page or other similar names and can substantially function as a main page from which the user 12 can navigate though the system 10. Moreover, in some embodiments, after creation of a user profile, the welcome page 68 can be the initial page displayed by the system 10 on the device 14 when the user 12 accesses the system 10, after the login page 13.

In some embodiments, the welcome page 68 can include a link 31 to an edit profile page 33, as shown in FIG. 9. In some embodiments, the edit profile page 33 can comprise at least some of the same fields included on the sign-up page 18. For example, in some embodiments, the edit profile page 33 can include fields related to the user's name 20, 22, e-mail address 26, password 28, phone number 30, gender 32, date of birth, 24, and zip code 64. In some embodiments, after creating the user's account, the user can continue to update their information as it changes over time using the edit profile page 33. Additionally, in some embodiments, the edit profile page 33 can include a link 35 to instruct the system 10 to activate the device's 14 GPS to at least partially determine the user's 12 location and substantially automatically update the user's location.

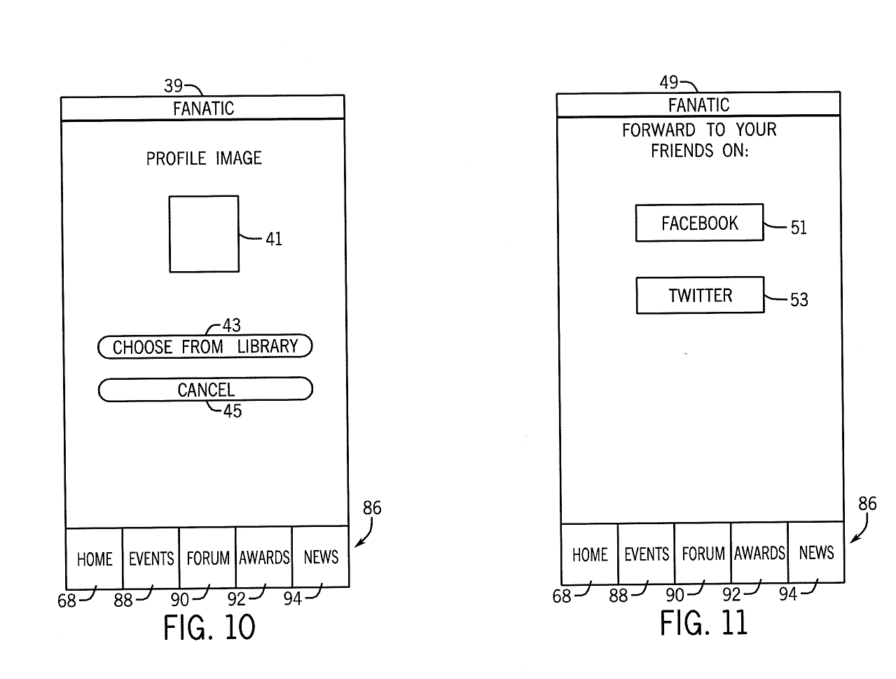

Also, in some embodiments, the edit profile page 33 can include a link 37 to an edit image page 39, as shown in FIG. 10. For example, in some embodiments, the system 10 can include a display of an image 41. In some embodiments, the image 41 can be a default image assigned by the system 10 until the user 12 decides to change the image 41. In some embodiments, the user 12 can change the image 41 by selecting a library button 43 on the edit image page 39. In some embodiments, by selecting the library button 43, the system 10 can access at least one of a locally stored database including images and a database connected to the system network. In some embodiments, after selecting the image 41 that the user 12 desires, the user 12 can select a cancel button 45 to return to the edit profile page 33.

In some embodiments, the edit profile page 33 can include a link 47 to a social networks page 49, as shown in FIG. 11. For example, in some embodiments, selecting the link 47, the system 10 can display the social networks page 49 so that the user 12 can select from at least one social networking system. As shown in FIG. 11, in some embodiments, the social networks page 49 can include links 51, 53 to pages of the system 10 for social networking systems, such as Facebook® and Twitter®. For example, in some embodiments, the user 12 can select one of the links to navigate to a Facebook® page 55 and/or a Twitter® page 57.

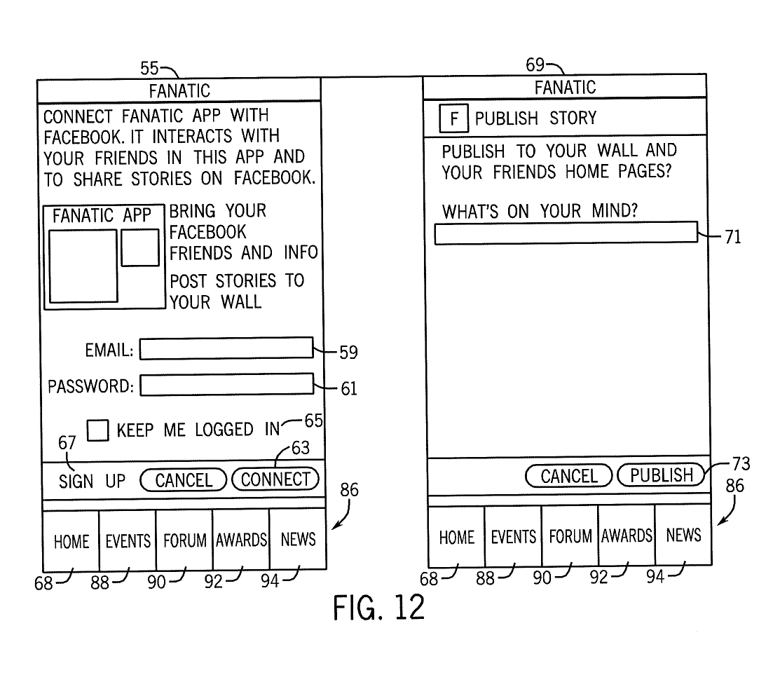

In some embodiments, the system 10 can display the Facebook® page 55 to at least partially enable the user 12 to connect their system 10 profile to the user's Facebook® profile. For example, as shown in FIG. 12, in some embodiments, the Facebook® page 55 can include fields for the user 12 to input their Facebook® login name 59 and Facebook® password 61. Also, in some embodiments, after inputting their information, the user 12 can select a connect button 63 to instruct the system 10 to initiate a login process. For example, in some embodiments, after receiving the user's Facebook®-specific information, the system 10 can communicate with Facebook® so that the two systems can share user-related social commentary. Additionally, in some embodiments, the Facebook® page 55 can include a feature 65 that can enable the system 10 to remain substantially continuously logged in to the user's Facebook® account. For example, in some embodiments, the user can select the feature 65 so that the system 10 can remain logged in to the user's Facebook® account and, as a result, the user 12 can avoid logging into their Facebook® account each time they use the system 10. Moreover, in some embodiments, the Facebook® page 55 can include a link 67 that the user 12 can select to create a Facebook® account.

In some embodiments, after logging in to their Facebook® account via the Facebook® page 55, the system 10 can display a Facebook® publication page 69. In some embodiments, the Facebook® publication page 69 can include a field 71 into which the user 12 can input commentary regarding subject matter related to or unrelated to the event. In some embodiments, after inputting at least some text into the field 71, the user 12 can select a publish button 73 which can lead the system 10 to transmit the text in the field to the user's 12 Facebook® account where the text will be displayed for others to view. Additionally, in some embodiments, the Facebook® page 55 and/or the Facebook® publication page 69 can include a cancel button 75 so that the user 12 can navigate away from these pages.

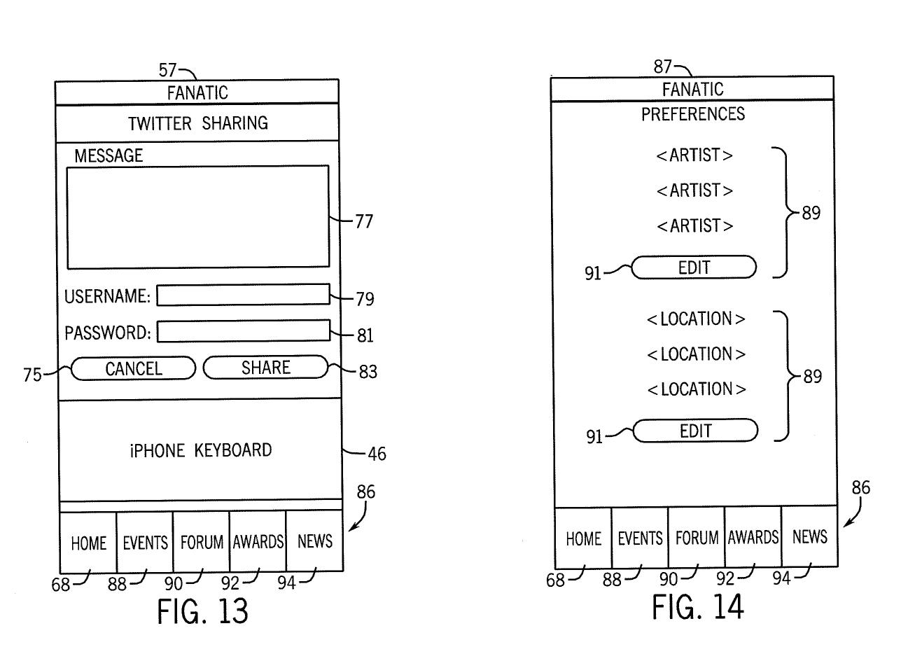

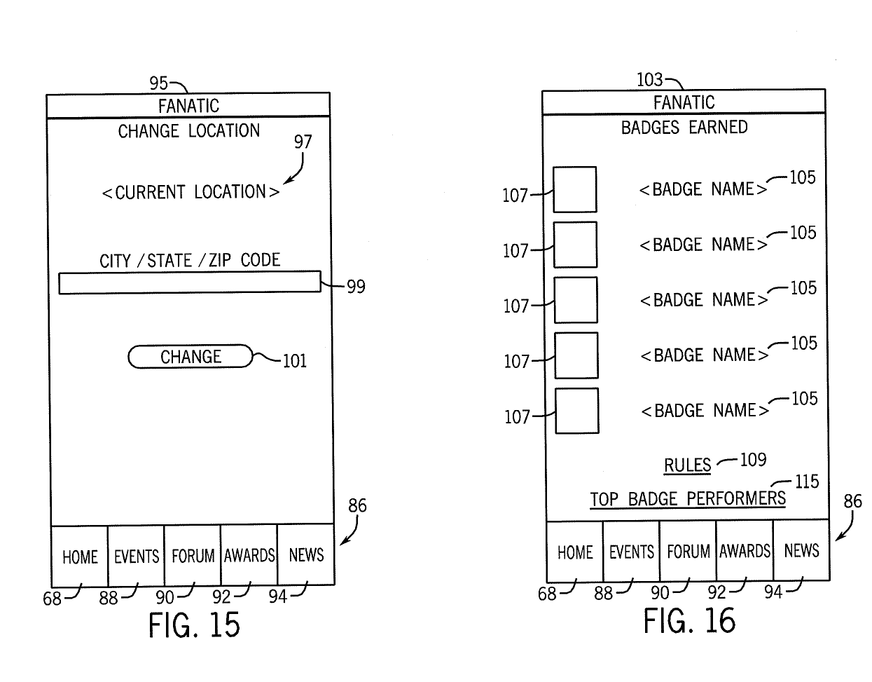

In some embodiments, the user 12 can instruct the system 10 to navigate to the Twitter® page 57, as shown in FIG. 13. In some embodiments, the Twitter® page 57 can include a field 77 into which the user 12 can input the message that they would like to share on the Twitter® network using the keyboard 46. Moreover, in some embodiments, the Twitter® page 57 can include a Twitter® username field 79 and a Twitter® password field 81 that the system 10 can use to enable communication with Twitter® to disseminate the user's 12 message. In some embodiments, the Twitter® page 57 can include a share button 83 that the user 12 can select the share button 83 to instruct the system 10 to communicate the message to Twitter®.

In some embodiments, the user 12 can continue to employ the edit profile page 33 to personalize the system 10 to their preferences. For example, in some embodiments, the edit profile page 33 can include a link 85 to an edit preferences page 87. In some embodiments, the user 12 can select the link 85 to instruct the system 10 to navigate to the edit preferences page 87, as shown in FIG. 14. In some embodiments, the edit preferences page 87 can include a list 89 of artists' names that the user inputted on the artist preferences page 40 and locations inputted on the location page 54 that the system 10 stored in the database. For example, as shown in FIG. 14, the system 10 can display three artists and three locations, however, in some embodiments, other numbers of each can be displayed. Moreover, in some embodiments, the edit preferences page 87 can comprise at least one edit button 91 that the user 12 can select to change the data currently displayed in the lists 89.

In some embodiments, after viewing, changing, editing, updating, and/or monitoring the values on the edit profile page 33, the user 12 can select the edit button 93 to signal the system 10 to update any databases to which the system 10 can store the values to reflect the changes. Accordingly, in some embodiments, the user 12 can continuously visit the edit profile page 33 and keep their profiles current so that the system 10 can display appropriate events.

In some embodiments, the welcome page 68 can display at least a portion of the data that the user 12 inputted during the user profile creation process previously mentioned. For example, in some embodiments, the welcome page 68 can display the user's first name 70, the user's location 72, and the user's current tally of rewards points 74. Additionally, in some embodiments, the welcome page 68 can display the results of the system's 10 analysis with respect to the user's profile and/or preferences. For example, in some embodiments, the welcome page 68 can display at least one upcoming event 76 based, at least in part, on the user's artist preferences page 40 input.

Further, in some embodiments, the user 12 can make changes to the welcome page 68 to at least partially personalize the welcome page 68. For example, in some embodiments, the user 12 select an upload image link 78 and transfer an image file (e.g., a .gif, .jpg, .tiff. .pdf, .bmp, etc.) from at least one of locally memory or the database. As a result, in some embodiments, the system 10 can display the selected image 41 each time the user 12 views the welcome page 68 until the user 12 wishes to changes the image, in which case the user 12 can once again select the upload image link 78 and select another image. In some embodiments, the system 10 can select a default image if the user 12 chooses not to transfer the image file. In some embodiments, when the user 12 selects the upload image link 78, the system 10 can direct the user 12 to the upload image page 39 so that the user 12 can update the image as previously mentioned.

Additionally, in some embodiments, the welcome page 68 can include a link 80 to a change location page 95. In some embodiments, the system 10 can direct the user 12 to the change location page 95 when the user 12 selects the link 80. In some embodiments, the change location page 95 can enable the user 12 to change their location. For example, in some embodiments, the change location page 95 can include a display of the current address 97 that the system 10 has stored in the database. Moreover, in some embodiments, the change location page 95 includes a field 99 into which the user 12 can input an address that the user 12 would like to have the system 10 store as the current location 97. In some embodiments, after entering the address, the user 12 can select a change button 101 to instruct the system 10 to update the address. In some embodiments, when the user 12 selects the location link 80, the system 10 can display the location page 54 previously mentioned so that the user 12 can repeat the location selection process, if desired.

In some embodiments, the welcome page 68 also can comprise connections to other information. For example, in some embodiments, the welcome page 68 can include a link 82 to a badges page 103. In some embodiments, by participating in, attending, observing, and/or viewing at least a portion of some events, the system 10 can provide the user 12 with at least one badge or symbol to recognize that the user 12 some how participated in the event (e.g., a patch or other symbol often sold at live events).

In some embodiments, the user 12 can select the link 82 to the badges page 103 to view at least at a portion of the badges awarded by the system 10 to the user 12. For example, as shown in FIG. 16, in some embodiments, the badges page 103 can include at least one badge name 105 and badge image 107. In some embodiments, by accessing the badge page 103, the user 12 can instruct the system 10 to access the database to determine which badges the user 12 has earned and then display the earned badges on the badges page 103. In some embodiments, the system 10 can display a plurality of badge names 105 and badge images 107.

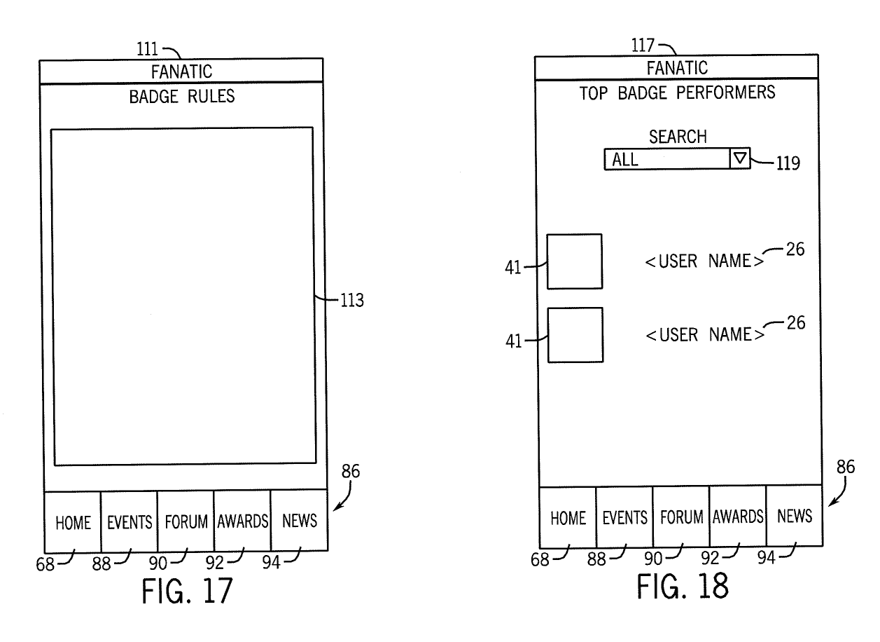

Moreover, in some embodiments, the badge page 103 can include a link 109 to a badge rules page 111. For example, in some embodiments, the user 12 can select the link 109 to view the rules that the system 10 uses to determine which badges are assigned for participation in which events. As shown in FIG. 17, in some embodiments, the badges rules page 111 can include text of the system's 10 rules 113 used to determine badge allocation.

In some embodiments, the badges page 103 can include a link 115 to a top badge performers page 117. For example, in some embodiments, as shown in FIG. 18, at least one leader in the number of badges earned can be included on the top badge performers 117. In some embodiments, the leaders can be determined based on a system-wide tally of badges per user 12. In some embodiments, the top badge performers page 117 can include a search function 119 that can allow the user 12 to search which users 12 are badge leaders. For example, in some embodiments, the search function 119 can sort badge leaders by location, event type, or can display the overall leaders (i.e., a system-wide leader). In some embodiments, the leaders can be displayed using their respective images 41 and usernames 26, as shown in FIG. 18. In some embodiments, by providing a listing of the badge leaders, the system 10 can foster more competition between users encourage more participation in events.

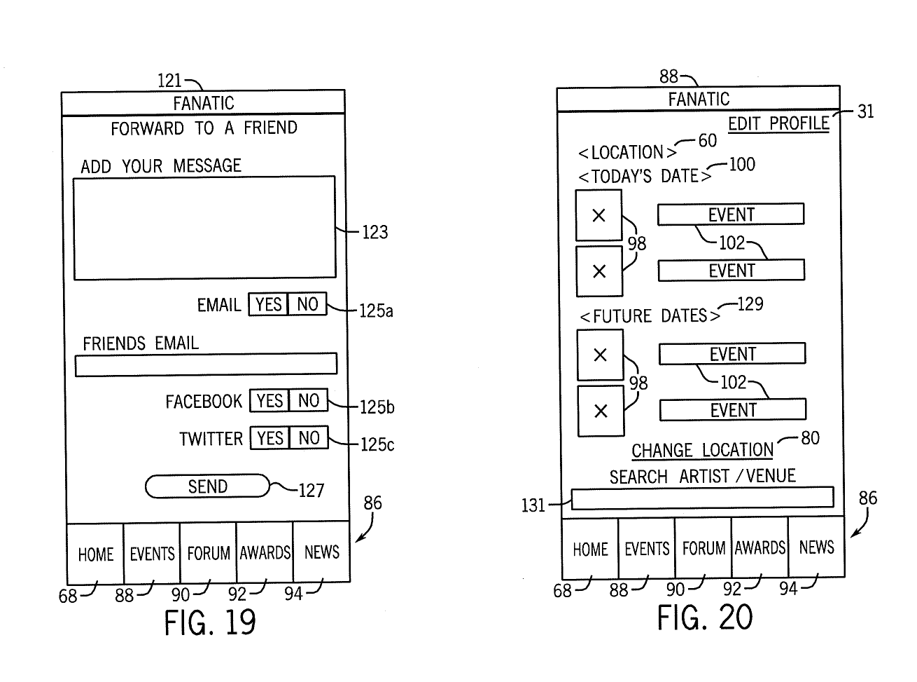

Additionally, in some embodiments, the welcome page 68 can include a link 84 to a forward to a friend page 121. In some embodiments, the user 12 can select the link 84 to share with a user's friend at least a portion of the information associated with the user 12. In some embodiments, the system 10 can navigate the user 12 to the forward to a friend page 121 when the user 12 selects the link 84. For example, as shown in FIG. 19, the forward to a friend page 121 can be configured and arranged to communicate information about the system 10 to a user's friend. In some embodiments, the forward to a friend page 121 can include a field 123 into which the user 12 can input text that can be sent to the user's friends. Moreover, in some embodiments, the page 121 can include delivery options 125 for forwarding the user's 12 message. For example, in some embodiments, the user 12 can indicate that the message should be forwarded to an acquaintance's e-mail address by indicating as such in the e-mail delivery option 125a. Accordingly, in some embodiments, the page 121 can include a field 127 into which the user 12 can input the acquaintance's e-mail address. Additionally, the system 10 can display other delivery options, such as postings to Facebook® 125b or Twitter® 125c. In some embodiments, after the user 12 determines which delivery options to employ, the user 12 can select the send button 127 to instruct the system 10 to send the message.

Additionally, in some embodiments, the welcome page 68 and some other pages displayed by the system 10 can comprise a menu 86. In some embodiments, the menu 86 can be positioned at or adjacent to a bottom of the user interface 16, although in other embodiments, the menu 86 can be positioned in other locations on the user interface 16. In some embodiments, the menu 86 can include links to a plurality of different pages associated with the system 10. For example, in some embodiments, the menu 86 can include links to the welcome page 68, an events page 88, a forum page 90, an awards page 92, and a news page 94. Accordingly, in some embodiments, from any variety of pages, the user 12 can select at least one of the menu's 86 options and the system 10 can access and display that page on the user interface 16. Additionally, in some embodiments, the user 12 can select the home/welcome page 68 option from the menu 86 to instruct the system 10 to return to the welcome page 68.

In some embodiments, the user 12 can select the events page 88 from the menu 86. In some embodiments, by selecting the events page 88 option, the system 10 can display the events page 88 on the user interface 16, as shown in FIG. 20. In some embodiments, the events page 88 can include information related to events occurring at different times (e.g., today and in the future). For example, as shown in FIG. 20, in some embodiments, the events page 88 can include the user's current location, as entered into the system 10 and stored as previously described. Additionally, in some embodiments, the current date 100 can be displayed. In some embodiments, the system 10 can also select relevant events based on the user's profile that are occurring on the current date 100. For example, in some embodiments, an image associated with the event 98 and a name of the event 102 can be displayed so that the user 12 can determine whether they would like to attend those events. Moreover, in some embodiments, similar event-related information regarding events occurring in the future can be displayed under a future dates heading 129. Additionally, in some embodiments, the events page 88 can include the link 80 to the change location page 95, where the user 12 can change their location, as previously mentioned.

In some embodiments, the events page 88 can include a search function 131. For example, as shown in FIG. 20, in some embodiments, the user 12 can input data, such as the name of an artist, a venue, an arena, a genre, etc. and the system 10 can display the results of that search so that the user 12 can determine whether they would like to attend any or all of those events. As a result, the system 10 can display to the user 12 multiple events so that the user 12 can decide in which events they would like to participate.

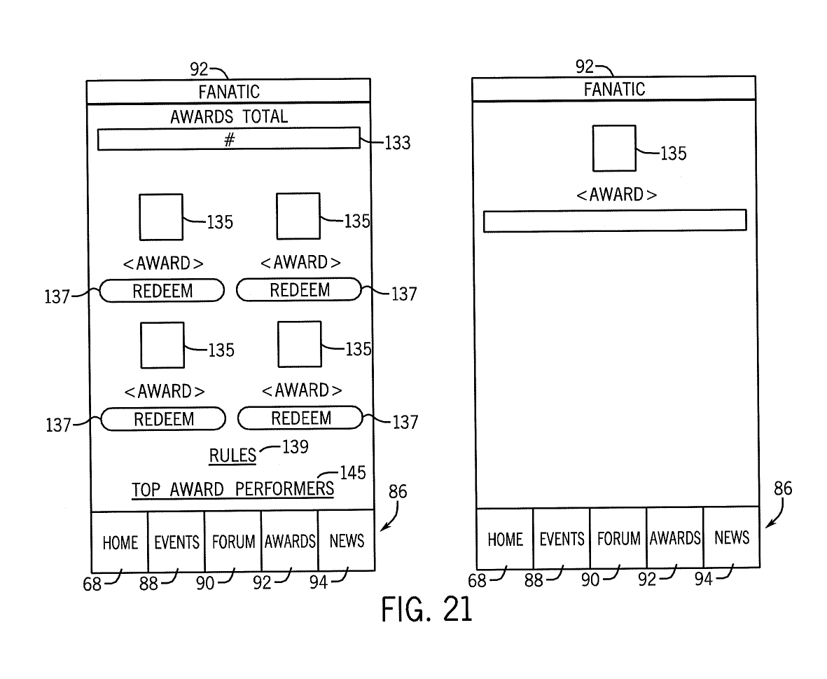

In some embodiments, the user 12 can select the awards page 92 from the menu 86. For example, in some embodiments, the user 12 can view their earned awards 92 by selecting the awards page 92. As shown in FIG. 21, in some embodiments, the awards page 92 can include a user-specific total of reward points 133. In some embodiments, the user 12 can accumulate reward points through use of the system 10, including participating in events, which can encourage user participation. In some embodiments, users 12 can redeem reward points for awards. For example, in some embodiments, on the awards page 92, the system 10 can display images 135 of at least one award that can be redeemed for a pre-determined number of reward points. In some embodiments, the user 12 can select the award(s) the user 12 would like to redeem for reward points by selecting a redeem button 137 displayed adjacent to the images 135.

Additionally, in some embodiments, the redemption process can comprise other elements. For example, in some embodiments, after the user 12 selects the redeem button 137, the system 10 can display an award redemption shadow page (not shown) for user 12 viewing. Also, in some embodiments, after the user 12 views the award redemption shadow page, the system 10 can display an award information page (not shown). In some embodiments, the award information page can provide further information to the user 12 regarding the selected award so that the user 12 can make an informed decision when redeeming rewards points.

In some embodiments, the user 12 can broadcast the reward points and/or awards to the user's welcome page 68 on the system 10 as well as to the user's other social networking services. In some embodiments, the awards can comprise clothing and other paraphernalia associated with the event, or additional tickets to other events.

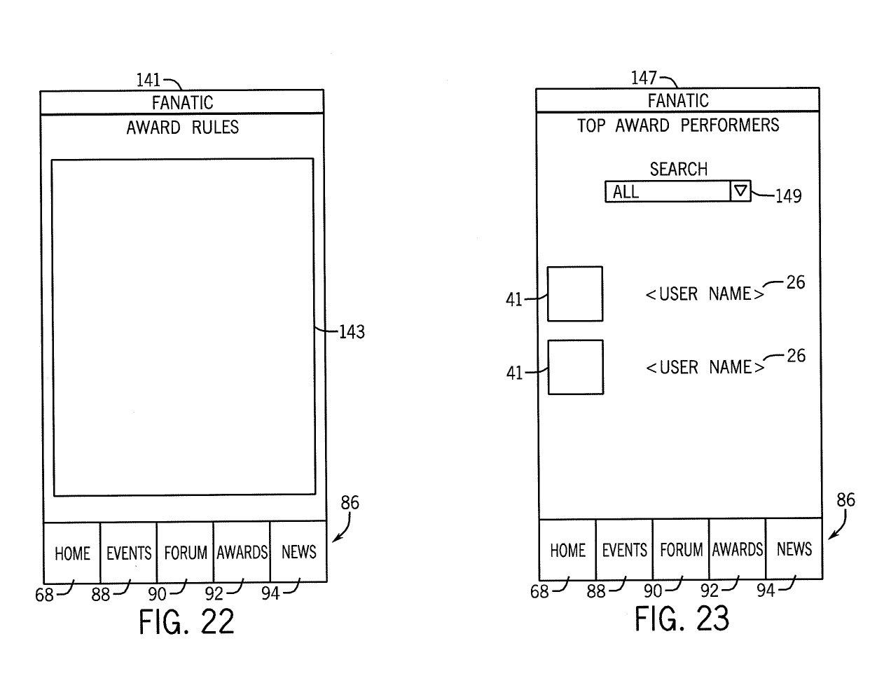

Moreover, in some embodiments, the awards page 92 can include a link 139 to a award rules page 141. For example, in some embodiments, the user 12 can select the link 139 to view the rules that the system 10 uses to determine award allocations. As shown in FIG. 22, in some embodiments, the award rules page 141 can include text of the system's 10 rules 143 used to determine award allocation.

In some embodiments, the awards page 103 can include a link 145 to a top award performers page 147. For example, in some embodiments, as shown in FIG. 23, at least one leader in the number of awards earned can be included on the top awards performers page 147. In some embodiments, the leaders can be determined based on a system-wide tally of awards per user 12. In some embodiments, the top awards performers page 147 can include a search function 149 that can allow the user 12 to search which users 12 are award leaders. For example, in some embodiments, the search function 149 can sort award leaders by location, event type, or can display the overall leaders (i.e., a system-wide leader). In some embodiments, the leaders can be displayed using their respective images 41 and usernames 26, as shown in FIG. 23. In some embodiments, by providing a listing of the award leaders, the system 10 can foster more competition between users encourage more participation in events.

For example, in some embodiments, as a result, the rewards can create an incentive program which can create value for ticketing companies and event organizers to work with the system 10 and its services. For example, as a result of decline in CD sales due to music piracy, the majority of revenue for artists comes from touring. By being able to target concert attendees, event organizers and artists can find value in providing targeted advertising and an incentive program that rewards users 12 for attending events. The incentive program can aim to increase concert attendance as well as ticket sales

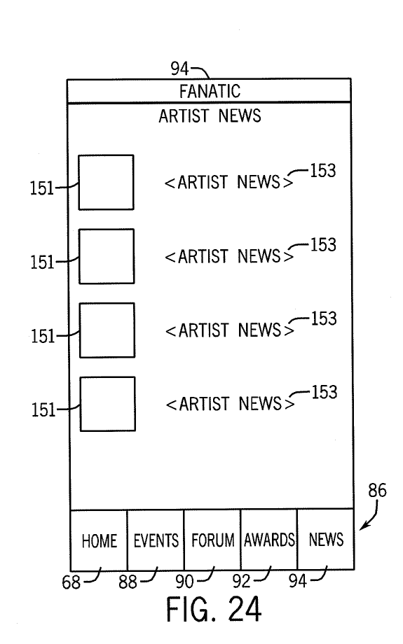

In some embodiments, the user 12 can select the news page 94 from the menu 86. For example, in some embodiments, if the user 12 wishes to view news or other current information related to artists or other people, teams, troupes, etc., the user 12 can instruct the system 10 to navigate to the news page 94. For example, as shown in FIG. 24, in some embodiments, the news page 94 can include a relevant image 151 and news story 153 for at least one artist and/or event. For example, in some embodiments, the system 10 can use different syndication protocols, such as RSS, to capture and share these images 151 and stories 153. In some embodiments, the news stories 153 can include upcoming events in the followed location, tour schedules of followed artists, new releases, etc.

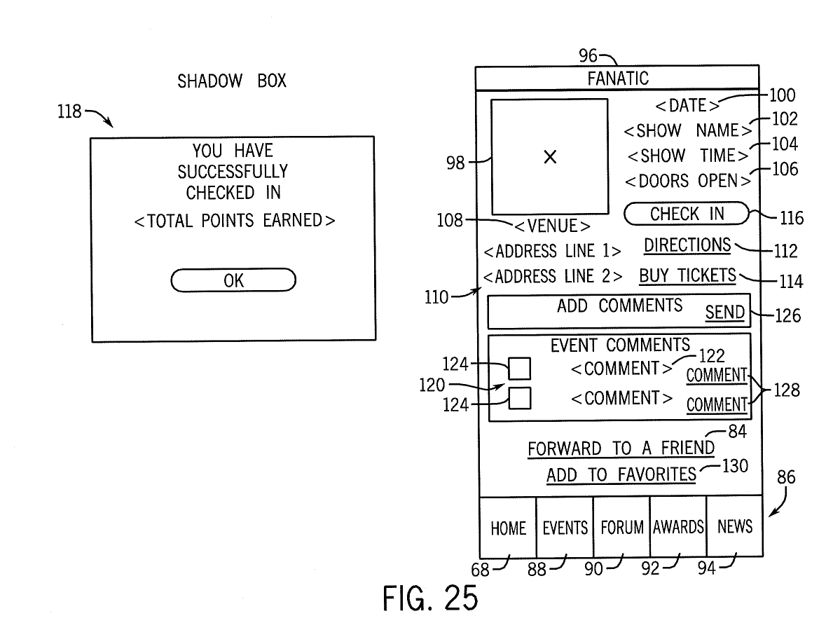

In some embodiments, the system 10 can display an events detail page 96, as shown in FIG. 25. In some embodiments, each event can include its own events detail page 96 (e.g., each events detail page 96 is substantially unique based on the event) and in other embodiments, more than one event can be included on an events detail page 96. In some embodiments, the events detail page 96 can comprise information related to any particular event that the user 12 selected and/or the analysis of the system 10 determined that the user 12 may enjoy. For example, in some embodiments, the events detail page 96 can include images 98 (e.g., graphic displays of an image symbolizing the event and/or the artists performing), a date of the event 100, the name of the event 102, a time of the event 104, a time that the event becomes publically available 106 (e.g., when the “doors open”), a name of the event's venue 108, and an address 110 for the venue 108.

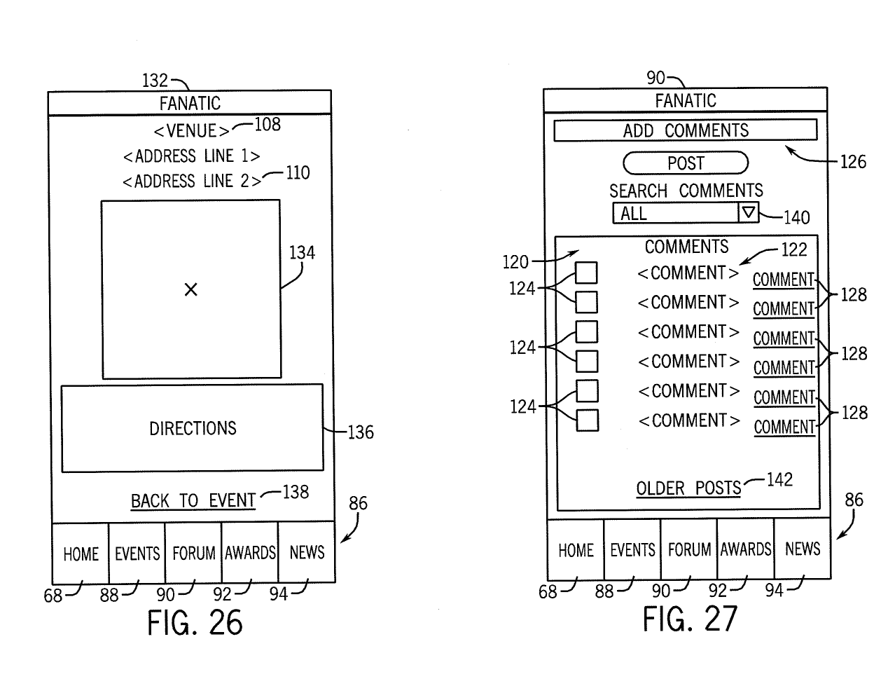

In some embodiments, the events detail page 96 can include a link 112 to a directions page 132. In some embodiments, the user 12 can select the link 112 to reach the directions page 132 to obtain an explanation of how to reach the event detailed on the event details page 96, as shown in FIG. 26. For example, in some embodiments, the directions page can include the venue 108 and the address of the venue 110. Additionally, in some embodiments, the directions page 132 can include a map 134. For example, in some embodiments, the map 134 can include a route highlighted for the user's benefit. In some embodiments, the directions page 132 can include written directions 136 to further explain the travel route to the event for the user's benefit. In some embodiments, the directions page 132 can include at least one of the map 134 and the directions 136. Moreover, in some embodiments, the directions page 132 can include a link 138 that the user 12 can select to return to the event details page 96. In some embodiments, the directions page 132 can be in communication with other systems, such as Google Earth and/or Mapquest to populate the directions 132 with information.

Moreover, in some embodiments, the events detail page 96 can include an event ticket purchase link 114 that can direct the system 10 to access at least one of a plurality of different ticket purchasing resources. In some embodiments, the system 10 can employ different processes to enable the user 12 to purchase event tickets. For example, in some embodiments, after the user 12 selects the event ticket purchase link 114, the system 10 can employ a technology, such as Click 2 Call to connect the user 12 with a ticket-purchasing resource.

In some embodiments, the event detail page 96 can comprise a check-in button 116. In some embodiments, the check-in button 116 can function as a way for the user 12 to signal their attendance at the event, which can lead to the system 10 providing benefits to the user 12. For example, in some embodiments, although the event detail page 96 can be displayed at substantially any time after the event's creation, the check-in button 116 can be displayed on the day of the event. Moreover, in some embodiments, after the user 12 selects the check-in button 116, the system 10 can recognize that the user 12 is participating, attending, observing, and/or engaging in the event so that the system 10 can issue some awards point value and/or one or more badges, as previously mentioned. Additionally, in some embodiments, after the user 12 selects the check-in button 116, the system 10 can display a check-in shadow box 118, which, in some embodiments, can inform the user 12 that they successfully checked-in to the event on the system 10 and display for the user 12 the number of points the user 12 earned by checking in to the event.

For example, in some embodiments, while attending the event, the user 12 can launch the system 10 on their device 14. In some embodiments, when the user 12 launches the system 10, if the device 14 has GPS capabilities, the system 10 can use the GPS to determine the event that the user 12 is attending. For example, the system 10 can be in communication with the system 10 service and/or network or a separate event service over the network that includes an event listing by location. In some embodiments the system 10 can then retrieve the event based on the user's 12 GPS location, and allow the user 12 to “check-in” to the event through the through the user interface 16, as previously mentioned. Additionally, in some embodiments, the system 10 can communication with the GPS to substantially automatically check-in the user 12 to the event.

In some embodiments, once the user 12 checks-in to the event, the system 10 can display information about the event (e.g., as retrieved from the system or other sources), such as artists performing at the event, statistics for each participating team at the event, etc., as previously mentioned. In some embodiments, the system 10 can also display any user friends or other friends who are also checked-in to the event through the system 10 (not shown).

In some embodiments, the user 12 can also communicate with the friends or other users also checked-in at the event. For example, the system 10 can provide the user 12 with options to view and post comments on message boards viewable by all users 12 or the user's friends at the event. In some embodiments, some of the user's posts to the message boards can also be forwarded as posts to the user's other social networking service, as described above and hereinafter.

In some embodiments, the system 10, via the event detail page 96, can also enable social communication and social networking. For example, in some embodiments, the event detail page 96 can include a commentary area 120. In some embodiments, the commentary area 120 can include comments 122 posted by other users 12 who have either checked in to event or are interested in the event. In some embodiments, the comments 122 can include other users' 12 analyses of the events and information related and unrelated to the event associated with the event detail page 96. In some embodiments, at least a portion of the comments 122 can include an image 124 of the user 12 who posted the comment 122. In some embodiments, the image 124 posted by the comments 122 can be the same image 41 on the welcome page 68. In some embodiments, the commentary area 120 can include a comment field 126 into which the user 12 can input their own comments regarding the event or other topics. Additionally, in some embodiments, the user 12 can either prepare their own comments, as previously mentioned, or the user 12 can reply to comments 122 already posted by other users 12. For example, in some embodiments, the user 12 can select the comment reply link 128 and draft and post their comments regarding another's comments 122. Additionally, in some embodiments, at least a portion of the comments 122 can originate from users 12 participating in the event (e.g., users substantially at or proximal to the event).

In some embodiments, the commentary area 120 and/or other portions of the event detail page 96 can comprise other ways to share user 12 experiences. In some embodiments, the event detail page 96 can include a link that the user 12 can select to upload at least one of images and video files (not shown). For example, in some embodiments, the commentary area 120 can include links that the user 12 can select to upload images and video files stored on the user's device 14 or stored on a database of the network. In some embodiments, the system 10 can enable distribution of the video and/or image to other user's 12 at the event by display the video and/or image on other user's 12 event detail page 96 related to this event. In some embodiments, the video and/or image can be related or unrelated to the event. In some embodiments, the comments 122 need not be written communications and can comprise an image or a video.

In some embodiments, the commentary area 120 can include a link (not shown) to the forum page 90. Also, in some embodiments, the user 12 can instruct the system 10 to navigate to the forum page 90 by selecting it on the menu 86. In some embodiments, the forum page 90 can be similar to the commentary area 120, as shown in FIG. 27. For example, in some embodiments, the forum page 90 can include the comment filed 126 into which the user 12 can input their comments on the event. Additionally, the forum page 90 can include comments 122 and associated images 124, 78 from the comments' 122 originators. In some embodiments, the user 12 can reply to comments 122 already posted by other users 12. For example, in some embodiments, the user 12 can select the comment reply link 128 and draft and post their comments regarding another's comments 122 on the forum page 90. In some embodiments, the forum page 90 can also include a search feature 140 that the user 12 can employ to organize the comments 122 using different criteria (e.g., all comments, artist-related comments, venue-related comments, city-related comments, event-related comments, etc.). Also, in some embodiments, the forum page 90 can include an older posts link 142. For example, in some embodiments, the system 10 can display more temporally relevant comments 122 on the forum page 90 and can allow access to older comments via selection of the older posts link 142. In some embodiments, the forum page 90 can also comprise links for user's 12 to upload images and/or videos related to or unrelated to the event.

Additionally, in some embodiments, the event detail page 96 can include other information. For example, in some embodiments, the event detail page 96 can include the forward to a friend link 84. In some embodiments, the event detail page 96 can include an add to favorites link 130. For example, in some embodiments, after selecting the add to favorites link 130, the user 12 can be guided to the edit preferences page 87 where the user 12 can add the event to reflect to the system 10, the user's 12 interest in the event. Also, in some embodiments, if the event is already a part of the user's profile, the system 10 can substantially function without the add to favorites link 130. Additionally, in some embodiments, the menu 86 also can be displayed on the event detail page 96 for user 12 navigation.

In some embodiments, the system service can also track the user's interaction with the system 10 and store such data in connection with the user's account in a database on the system's servers. As previously mentioned, in some embodiments, the system 10 can use such data to create an in-depth profile of the user's likes and dislikes by tracking every event that the user 12 checks into and gaining access to artists that are stored on their device 14. In some embodiments, the system 10 can also use such data to provide targeted advertising to the user 12 through the system service, similar to targeted advertising for websites. In one embodiment, the advertisements can generate revenue on a Cost Per Click (CPC) model. In comparison to traditional website advertising, the system service can charge higher CPC rates because of a better-defined target audience of users (e.g., due to the knowledge of the user's location, interests, events attending, etc.). In addition, the application service can provide Short Message Service (SMS), or text message, advertising.

In some embodiments, ticketing companies can have access to portions of the users' information and data from the system service. For example, the system service can provide a user's name, gender, age, email, phone number, what artist they like, what shows they have been to in the past, the locations the user will visit to see a show to the ticketing companies. In some embodiments, having an in-depth customer database can be valuable to the ticketing companies for more defined marketing opportunities for the users.

As previously mentioned, some embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way. It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of location-based social networking, the method comprising:
creating a user profile including
receiving a plurality of data inputs from a user,
storing the plurality of data inputs in a database,
distributing a first reward to the user for creating the user profile, and
displaying at least a portion of the plurality of data inputs on a welcome page;
determining a location of the user using at least one of a global positioning system and data input from the user;
displaying at least one event on at least one of the welcome page and an event page, the selection of the event is at least in part based on a location of the event;
receiving an event check-in instruction from at least one of the global positioning system and the user;
distributing a second reward to the user;
receiving at least one comment from the user regarding the event;
displaying the at least one comment on at least one of an event details page and a forum page; and
transmitting the at least one comment to at least one social networking account associated with the user.

2. The method of claim 1, wherein the plurality of data inputs from the user comprises at least two of the user's name, e-mail address, date of birth, gender, and artist preference.

3. The method of claim 1, wherein the at least one social networking account is one of Facebook® and Twitter®.

4. The method of claim 1, wherein the event comprises one of a music performance, sporting event, and a social event.

5. The method of claim 1 and further comprising displaying event-specific information on the event details page.

6. The method of claim 1 and further comprising displaying the names of other users checked-in to the event.

7. The method of claim 6, wherein at least one of the other users responds to the at least one comment displayed on the at least one of the event details page and the forum page.

8. The method of claim 1 and further comprising receiving instructions to redeem at least a portion of the first and the second rewards.

9. The method of claim 1 and further comprising distributing to the user profile at least one badge after receiving the event check-in instruction.

10. The method of claim 1 and further comprising displaying at least one menu.

11. A method of location-based social networking, the method comprising:
displaying at least two of a sign-up page, an artist preference page, and a location page, each page is configured and arranged to receive data at least partially related to event preferences;
receiving the data, wherein a global positioning system generates at least a portion of the data;
storing the data in a system database;
displaying at least a portion of the data on a welcome page;
distributing a first reward, the first reward at least in part based on receiving the data;
displaying at least one event on the welcome page, the event selected at least in part based on the data received;
receiving an event check-in instruction;
distributing a second reward, the second reward at least in part based on receiving the event check-in instruction;
receiving at least one first comment related to the event, the first comment originating from a location substantially proximal to the event;
displaying the first comment on at least one of an event detail page and a forum page;
receiving at least one second comment, the second comment received in response to the first comment; and
transmitting at least one of the first comment and the second comment to at least one social networking system.

12. The method of claim 11, wherein the data comprises at least one of a user's name, e-mail address, date of birth, gender, and artist preference.

13. The method of claim 11 and further comprising displaying at least one news story related to the event on the forum page.

14. The method of claim 11, wherein the event check-in instruction is at least partially generated by the global positioning system.

15. The method of claim 11 and further comprising distributing at least one badge after receiving the event check-in instruction.

16. The method of claim 11 and further comprising displaying at least one of a badge leader page and a rewards leader page.

17. The method of claim 11 and further comprising transmitting the data for use in targeted advertising.

18. The method of claim 11, wherein the at least one social networking system is one of Facebook® and Twitter®.

19. A system for location-based social networking, the system comprising:
at least one device connected to a network and a database, the at least one device configured to:
create a profile including
receiving a plurality of data inputs,
storing the plurality of data inputs in the database connected to the device,
distributing a first reward for creating the profile, and
displaying at least a portion of the plurality of data inputs on a welcome page;
determine a location of the device using at least one of a global positioning system and data input;
displaying at least one event on at least one of the welcome page and an event page, the selection of the event is at least in part based on the location of the event;
receiving an event check-in instruction from the global positioning system;
distributing a second reward for receiving the event check-in;
receiving at least one comment regarding the event;
displaying the at least one comment on at least one of an event details page and a forum page; and
transmitting the at least one comment to at least one social networking account associated with the user.

20. The system of claim 19, wherein the device comprises one of a tablet computer, a laptop computer, a smartphone, and a personal digital assistant.
